(19) United States
(12) Patent Application Publication
(10) Pub. No.: US 2010/0149925 A1
(43) Pub. Date: Jun. 17, 2010

(54) Holiday decoration with an electronic countdown feature

(76) Inventor: Hon Kwok Cheng, Kowloon (HK)

Correspondence Address: KEVIN J. MCNEELY, ESQ., 5335 WISCONSON AVENUE, NW, SUITE 440, WASHINGTON, DC, 20015, US

(21) Appl. No.: 12/600,469

(22) PCT Filed: Jul. 23, 2007
(86) PCT No.: PCT/CN2007/070339

§ 371 Date: Nov. 16, 2009

(51) Int. Cl. G04B 47/04; G04F 10/00

(52) U.S. Cl. 368/109; 368/108; 368/285

(57) ABSTRACT

A holiday decoration with an electronic countdown feature, comprising: a decoration body (1) comprising a panel with a display area (2); and an electronic countdown device being attached to the decoration body and comprising: a processor (100) calculating and determining remaining time preceding a target holiday based on an input current time after a number of remaining days left till the target holiday is set; a display (300) connected to and correspondingly arranged with the processor in the display area of the panel for showing the remaining time preceding the target holiday; one or more adjustment control keys (200) connected with the processor and arranged on the display for provision of the current time to the processor; and a battery (400) for provision of power to the electronic countdown device.

### TECHNICAL FIELD

The present invention relates to a holiday decoration, and particularly to a compact holiday decoration with an electronic countdown feature.

### BACKGROUND OF THE INVENTION

The existing countdown devices are mainly used for anticipation of major events, for example, the Olympic Games, regional games, or international large-scale events; or for countdown of major festivals, such as Christmas, New Year, and so on. They are generally installed at major sites of relevant cities as fixed structures being large in size and complex in structure, thereby they are not suitable for use in home or small locations.

US patent application US2005/281028A1 discloses a Count-Down-to-Christmas-Scene-Device adapted for domestic use and configured to count down the 12 days to Christmas. The device includes a Christmas scene and 12 numbered Christmas lights respectively marked with numbers 1 to 12, wherein the numbered Christmas light from 12 to 1 will light up according to the number of days left till Christmas. However, the Count-Down-to-Christmas-Scene-Device disclosed in this US patent application only counts down the 12 days to Christmas. This device, however, does not provided for showing the hours, minutes, and seconds, and performing automatic countdown and timing functions. Furthermore, such a device is not able to set the amount of time left before the holiday to be designated based on current time, while this can be performed according to the present invention.

Taking into account the foregoing, it is desirable to provide an innovative decoration integrating the countdown feature with a decorative item marking the days to which any holiday or special event is coming up. It will proceed to an automatic countdown as long as the days preceding the target holiday are set and the current time is inputted. The decoration with a countdown feature of the present invention is compact and relatively light in weight, and may be placed in a small space, such as in a home or an apartment, or in a public location, whereby creating a pleasant holiday atmosphere and enhancing the joy and anticipation for the holiday or special event.

### SUMMARY OF THE INVENTION

In order to produce the above effects, an object of the present invention is to provide a decoration with a countdown feature being completely innovative in design and function, whereby meeting the requirements for use in home or small locations.

According to the present invention, the decoration with a countdown feature comprising:
a decoration body comprising a panel with a display area; and
an electronic countdown device being attached to the decoration body and comprising:
   a processor calculating and determining remaining time preceding a target holiday based on an input current time after a number of remaining days left till the target holiday is set;
   a display connected to and correspondingly arranged with the processor in the display area of the panel for showing the remaining time preceding the target holiday;
   one or more adjustment control keys connected with the processor and arranged on the display for provision of the current time to the processor; and
   a power supply for provision of power to the electronic countdown device.

Preferably, the decoration body comprises a Christmas decoration, a New Year decoration, a birthday decoration, a decoration with words, and a combination thereof. In a preferred embodiment of the present invention, the decoration body is a decoration panel in shape of Santa Claus, wherein at the rear of the decoration panel a deflectable support is arranged for a firm support of the decoration panel, and hanging rings are respectively arranged at upper and lower ends of the decoration panel, by which the decoration could be hanged on wall or other objects.

Preferably, the processor is an IC chip calculating and determining remaining time preceding the target holiday according to a preset program. Specifically, the processor is programmed to utilize the input current time as an initial value to calculate, determine and show the remaining time preceding the target holiday on the display after the number of remaining days left till the target holiday is set, and send a message upon completion of countdown.

Preferably, the display is a LCD digital display comprising a days display section, an hours display section, a minutes display section and a seconds display section, wherein all display sections are correspondingly arranged in the display area of the panel of the decoration body; wherein the days display section, the hours display section, the minutes display section and the seconds display section respectively have an initial maximum value of 99 days, 24 hours, 60 minutes and 60 seconds.

In the foregoing decoration, the power supply could be an AC or DC power supply. Preferably, an AC power supply is employed, and a power interface and a DC/AC converter could be arranged on the electronic countdown device for connection with the AC power supply. Alternatively, a battery could be arranged in the electronic countdown device for supplying a DC power thereto.

Preferably, it further comprises a backup battery connected with the processor, such that the processor could keep up countdown operation even the power supply is cut off.

Preferably, the decoration further comprises a power interface and a DC/AC converter for connection with the AC power supply.

Preferably, one or more sets of LED lights for illumination or decoration purpose are mounted in the decoration. Alternatively, a music player for playing a theme of holiday upon completion of countdown is integrated therein.

In a specific embodiment, the electronic countdown device comprises three adjustment control keys being respectively a set/shift key, a value increment key, and an exit key for setting required entries thereof.

The present invention is advantageous in that: it is simple in structure, easy to adjust, move and install; wherein the decoration body could be devised into various decorative forms, and equips with decorative items, text, or a combination thereof, in relation to various holidays or specific dates (such as decorative items for Christmas); and it could be further embedded with lightings or musical apparatus, whereby creating a pleasant holiday atmosphere and enhancing seasonal joy and anticipation. Further, the present invention is compact and could be placed in a small space, such as an apartment or a small space in a public location.

The objects, features and effects of the present invention will be more fully understood from the following description taken in conjunction with the accompanying drawings in which the concepts, concrete configurations and technical effects of the present invention are further illustrated, while such drawings are merely for illustrative purpose and should not be regarded as limiting the present invention.

### BRIEF DESCRIPTION OF THE DRAWINGS

FIG. 1 is a front view of an embodiment of the present invention;

FIG. 2 is a rear view of the embodiment as shown in FIG. 1;

FIG. 3 is a left view of the embodiment as shown in FIG. 1 in which a deflectable support is in an unfolded and supporting state;

FIG. 4 is a block diagram of basic units of an electronic countdown device for used in the present invention; and

FIG. 5 is a circuit diagram of the embodiment of the present invention.

### DETAILED DESCRIPTION OF THE PREFERRED EMBODIMENTS

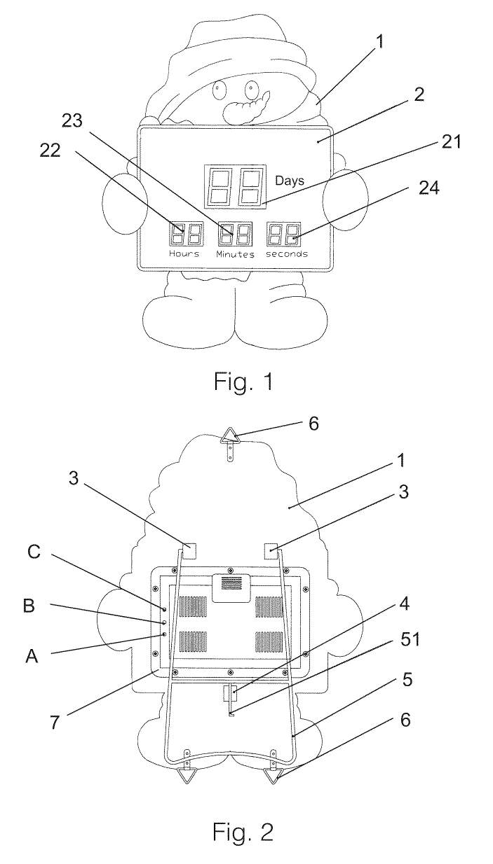

Referring to FIGS. 1-3, a decoration with a countdown feature of the present invention comprises a decoration body; in the embodiment, the decoration body is a decoration panel 1 in shape of Santa Claus, on which corresponding words could be fitted (not shown). At the front middle portion of the decoration panel 1 a display area 2 is arranged, on which there are 4 display portions 21, 22, 23, 24, being respectively arranged for showing the number of days, hours, minutes and seconds. At the upper portion of the rear face of the decoration panel 1 two holding pieces 3 having transversal insertion holes are arranged, while a holding piece 4 having a longitudinal insertion hole is arranged at the lower portion thereof. Two upper free ends on an approximately U-shaped support 5 are oppositely bent and inserted into the respective insertion holes of the holding pieces 3, whereby making the support 5 to be deflectable with respect to the decoration panel 1. A hanging stick 51 is articulated at the middle portion of a crossbar located at the support 5, a free end of which is provided with a hook for hooking to the insertion hole of the holding piece 4 of the decoration panel 1 when the support 5 is in a supporting state, so as to maintain the stability of the support 5. Further, hanging rings 6 could be respectively arranged at upper and lower ends of the decoration panel 1 for hanging on the wall or other objects.

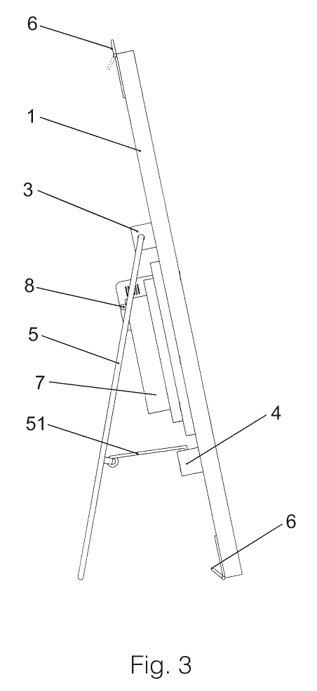

The decoration with a countdown feature further comprises an electronic countdown device being mounted between the upper and lower holding pieces 4, 5 of the decoration panel 1. As shown in FIGS. 2 and 3, the electronic countdown device comprises: a multi-stage rectangular housing 7; a processor 100 mounted in the housing 7; a display 300 connected to the processor and comprising a days display section, an hours display section, a minutes display section and a seconds display section; and three adjustment control keys 200 connected with the processor and arranged on the display; and a DC/AC converter 500, and a power interface arranged on the housing 7 for connection with the municipal AC power supply.

The processor 100 calculates and determines remaining time preceding a target holiday based on an input current time value after a number of remaining days left till the target holiday is set. In the embodiment, the processor 100 is an IC chip, which calculates and determines remaining days and times preceding Christmas day accordingly to a preset program. Once the number of remaining days to reach Christmas is set and the current time is inputted by means of the adjustment control keys A, B, C, the processor will start the countdown automatically, i.e. subtracting 24 hours and 60 minutes from the current time (hours and minutes). The remaining times are showed on the display. When Christmas has been reached, it makes some sort of signal to indicate that the countdown in over.

The display 300 is a LCD digital display having its four display sections correspondingly arranged in the display portions 21,22,23,24 of the display area 2 of the decoration panel 1, wherein the days display section, the hours display section, the minutes display section and the seconds display section respectively have a maximum initial value of 99 days, 24 hours, 60 minutes and 60 seconds; and the values shown therein are countdown parameters.

In the embodiment, the adjustment control keys 200 comprise three keys A, B and C, which are respectively a set/shift key, a value increment key, and an exit key. In normal operation, key A is pressed to enter a setup mode, and then blanking lights on corresponding locations will be accompanied and in such locations a desired term value should be set up. In the setup mode, if key B is pressed once, a value shown at the blinked location will be increased by 1. The countdown mode will be resumed once the key C is pressed in any setup mode.

A backup battery 400, such as a storage battery, connected with the processor 100, might also be mounted in the housing 7. In this way, even the AC power supply is cut off, the backup battery could still power the processor and maintain the normal countdown operation thereof. Certainly, it is obvious to a person skilled in the art that the AC power supply could be substituted by a battery, such as a DC storage battery for supplying directly a DC power thereto.

As shown in FIG. 5, one or more sets of LED lights 600 and a music player circuit (not shown) could be embedded in the holiday decoration of the present invention, thereby producing an excellent decoration effect and creating a joyful holiday atmosphere with the aid of colorful lighting variation of the LED lights and the music played therefrom.

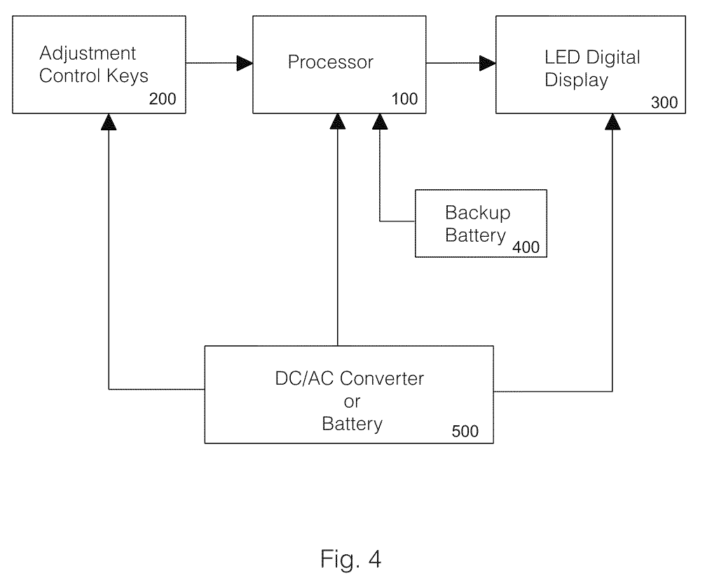

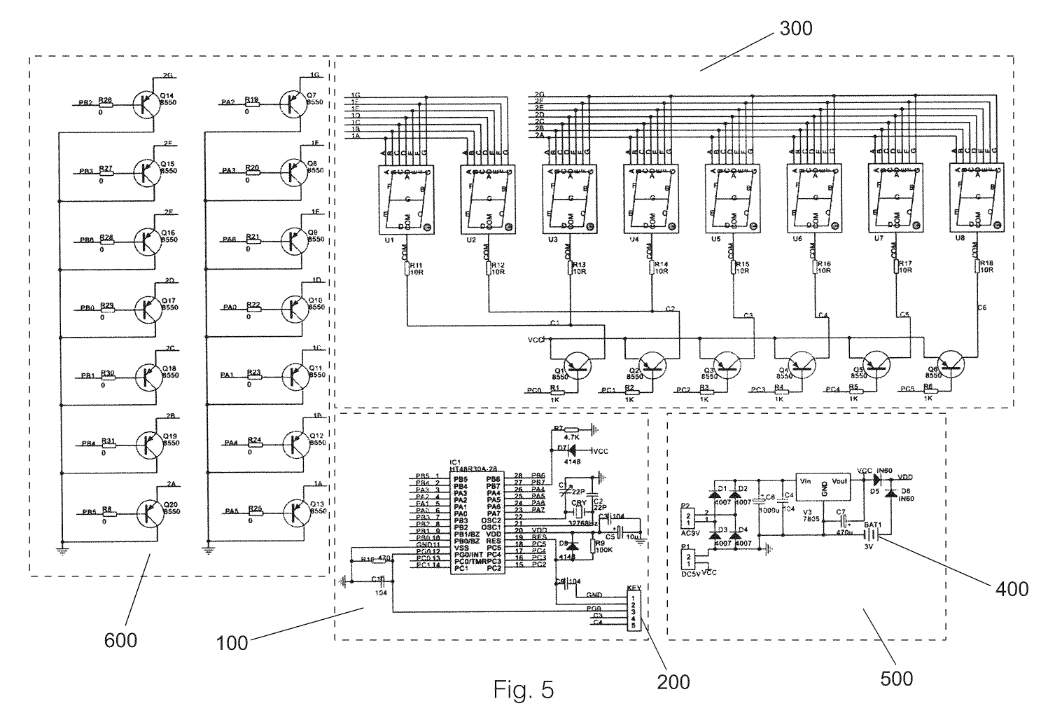

FIGS. 4 and 5 are respectively a block diagram of an electronic countdown device for used in the present invention and a circuit diagram of an embodiment of the present invention, wherein three adjustment control keys A, B, C and the LED display 300 are respectively connected with the processor 100. The remaining days based on the date of Christmas is set and the hours, minutes, and seconds for the time being are inputted by pressing respectively the adjustment control keys A, B, or C, so that the electronic countdown device will initiate automatically the countdown operation, wherein the maximum countdown time is 99 days.

While in the setup mode, the concrete operations are as follows:
1. Press key “A”, blinking of the number of countdown days will occur, and the number of the countdown days could be adjusted by pressing key “B”;
2. Press key “A” after the number of the countdown days is set, blinking of the countdown hours will occur, and the number of the countdown hours could be adjusted by pressing key “B”;
3. Press key “A” after the number of the countdown hours is set, blinking of the countdown minutes will occur, and the number of the countdown minutes could be adjusted by pressing key “B”;
4. Press key “A” to exit from the setup mode after the number of the countdown minutes is set, and the countdown mode will be resumed; and
5. In any setup mode, the normal countdown mode will be resumed by pressing key “C”.

The decoration with the countdown feature of the present invention could be adapted for indoor or outdoor use, and the countdown operation will be always maintained by virtue of the backup battery connected with the processor. A compact decoration creating a holiday atmosphere and being adapted for use in home or small locations will be thus formed by integrating therewith and mounting thereon the decorative items, texts, scenes, or the like dedicated for holidays or specific dates.

While the preferred embodiments of the present invention have been described in detail, it will be understood by those skilled in the art that various alterations or modifications might be made without departing from the design ideology and concept thereof. It should be appreciated that such alterations or modifications all fall into the scope of the present invention.

What is claimed is:

1. A holiday decoration with an electronic countdown feature, comprising:
a decoration body comprising a panel with a display area; and
an electronic countdown device being attached to the decoration body and comprising:
a processor adapted to calculate and determine remaining time preceding a target holiday based on an input current time after the number of remaining days left till the target holiday is set;
a display connected to the processor and correspondingly arranged in the display area of the panel for showing the remaining time preceding the target holiday;
one or more adjustment control keys connected with the processor and arranged on the display for provision of the current time to the processor; and
a power supply for provision of power to the electronic countdown device.

2. A holiday decoration according to claim 1, wherein the decoration body comprises a Christmas decoration, a New Year decoration, a birthday decoration, a decoration with words, and a combination thereof.

3. A holiday decoration according to claim 2, wherein the decoration body is a decoration panel in shape of Santa Claus.

4. A holiday decoration according to claim 3, wherein at the rear of the decoration panel a deflectable support is arranged for a stable support of the decoration panel.

5. A holiday decoration according to claim 3, wherein hanging rings are respectively arranged at upper and lower ends of the decoration panel.

6. A holiday decoration according to claim 1, wherein the processor is an IC chip calculating and determining remaining time preceding the target holiday according to a preset program.

7. A holiday decoration according to claim 6, wherein the processor is programmed in such a way that it can calculate, determine and show the remaining time preceding the target holiday on the display based on the input current time acting as an initial value after the number of remaining days left till the target holiday is set, and it can make some sort of signal after the countdown is over.

8. A holiday decoration according to claim 1, wherein the display is a LCD digital display comprising a days display section, an hours display section, a minutes display section and a seconds display section, wherein all display sections are correspondingly arranged in the display area of the panel of the decoration body.

9. A holiday decoration according to claim 8, wherein the days display section, the hours display section, the minutes display section and the seconds display section respectively have a maximum initial value of 99 days, 24 hours, 60 minutes and 60 seconds.

10. A holiday decoration according to claim 1, wherein it further comprises a power interface and a DC/AC converter for connection with an AC power supply and acting as the power supply of the electronic countdown device.

11. A holiday decoration according to claim 1, wherein a battery is used to supply power to the electronic countdown device.

12. A holiday decoration according to claim 1, wherein it further comprises a backup battery connected with the processor, whereby keeping the processor in good order even though the power supply is cut off.

13. A holiday decoration according to claim 1, wherein one or more sets of LED lights for illumination or decoration purpose are mounted in the holiday decoration.

14. A holiday decoration according to claim 1, wherein a music player for playing a theme of holiday upon completion of countdown is mounted in the holiday decoration.

15. A holiday decoration according to claim 1, wherein the electronic countdown device comprises three adjustment control keys being respectively a set/shift key, a value increment key, and an exit key.
